(19) United States
(12) Patent Application Publication
(10) Pub. No.: US 2020/0399069 A1
(43) Pub. Date: Dec. 24, 2020

(54) DAMPING STATION FOR AN OVERHEAD CONVEYOR SYSTEM, AND METHOD FOR DAMPING VIBRATIONS OF CARGO OF AN OVERHEAD CONVEYOR SYSTEM

(71) Applicant: EISENMANN SE, Böblingen (DE)

(72) Inventor: Marc Walter Kirchner, Bammental (DE)

(21) Appl. No.: 16/971,560

(22) PCT Filed: Jan. 31, 2019
(86) PCT No.: PCT/EP2019/052346

§ 371 Date: Aug. 20, 2020

(30) Foreign Application Priority Data
Feb. 23, 2018 (DE) 10 2018 104 208.6

(51) Int. Cl. B65G 19/18; B25J 9/16; B25J 5/02; B25J 13/08; B65G 19/02

(52) U.S. Cl. CPC B65G 19/185; B25J 9/1633; B65G 2812/99; B25J 13/08; B65G 19/025; B25J 5/02

(57) ABSTRACT

A damping station for an overhead conveyor system for damping vibrations of cargo, wherein overhead conveyor system cargo can be conveyed suspended from the overhead conveyor system. The damping station includes a vibration detection device designed to generate a signal in accordance with a mechanical vibration state of cargo suspended from the conveyor device, a damping device with a mechanical contact device movable by an actuator, the contact device being designed to enter into mechanical operative connection with cargo suspended from the conveyor device, and a control unit, which is connected at least to the vibration detection device and the damping device, the control unit being designed to actuate the damping device depending on the signal of the vibration detection device such that, by means of the actuator, a force is exerted onto the cargo via the contact device in such a way that a vibration of the cargo is damped. A method for damping vibrations in cargo on an overhead conveyor system is also provided.

### BACKGROUND OF THE INVENTION

### 1. Field of the Invention

The invention relates to a damping station for an overhead conveyor system for damping vibrations of load goods, wherein by means of the overhead conveyor system load goods can be conveyed overhead by conveying devices. Furthermore, the invention relates to a method for damping vibrations of load goods of an overhead conveyor system, wherein by means of the overhead conveyor system load goods can be conveyed overhead by conveying devices.

### 2. Description of Prior Art

An overhead conveyor system is herein to be understood as a conveying system in which load goods can be conveyed overhead by conveying devices. Examples of this are rail-supported and rail-guided conveyor systems in which the conveying device runs on a support rail and is driven by a drive means such as a chain. Such conveyor systems are also called power and free conveyor systems or drag conveyors. Furthermore, the term overhead conveyor system is also to be understood to include, for example, electric overhead conveyors in which rail-bound conveying devices also have individually driven and controllable vehicles that can move independently on the rail system. Also so-called trolleys, in which the load good is suspended at only one point on the load-bearing conveying device, are to be covered by the term overhead conveyor system.

Such overhead conveyor systems are known per se and are used, for example, to convey load goods such as workpieces in production plants through pre-treatment, painting, drying and/or cooling cabins. Examples in the field of parts transport are lifting frames for forklift trucks, vehicle frames or trailer frames. Such load goods are usually connected to the conveying device at at least two suspension points and, due to their high mass, tend to oscillate after accelerations, especially transversely to the conveying direction. Such oscillation movements can interfere with existing work processes, such as surface treatments like cleaning or coating. Possible known countermeasures are particularly long travel distances or waiting positions, in order to allow the load to swing out, or fixed stops in the travel area against which the load good can strike. However, these measures are at the expense of cycle time, flexibility or the quality of the load good.

Alternatively, it is known that when transporting load goods on overhead conveyors, accompanying damping systems are provided to reduce the oscillating movements. These damping systems can, for example, change direction and/or acceleration between the actual conveying device and a transport frame or a transport platform. With the heavy load goods mentioned above, however, it is common practice to fasten the load goods directly to the conveying device using rods, ropes and/or chains without additional transport frames or transport platforms.

### SUMMARY OF THE INVENTION

It is therefore an object of the invention to provide a damping station for an overhead conveyor system for the damping of vibrations of load goods, which avoids the mentioned disadvantages and in particular enables a damping of vibrations of the load good with a high cycle time and a high flexibility of the entire system.

The object is solved by a damping station according to the independent device claim. Furthermore, the object is solved by a method for damping vibrations according to the independent method claim.

The damping station according to the invention for an overhead conveyor system for damping vibrations of load goods, wherein by means of the overhead conveyor system load goods can be conveyed overhead by conveying devices, comprises a vibration detection device configured to generate a signal corresponding to a mechanical vibration state of a load good suspended on the conveying device, a damping device with a mechanical contact device which is movable by means of an actuator, the contact device being configured to engage in a mechanical operative connection with a load good suspended on the conveying device by means of the actuator, and a control device connected at least to the vibration detection device and the damping device, wherein the control device is configured to control the damping device in dependence on the signal of the vibration detection device such that by means of the actuator a force is exerted on the load good via the contact device such that a vibration of the load good is damped.

It is thus possible to exert a force on the possibly oscillating or vibrating load good by means of the damping device via the contact device and thus to apply a force against the momentary oscillation or vibration direction. The force can be exerted when the conveying device is at a standstill or simultaneously with a transport movement of the conveying device.

A preferred embodiment provides that the control device is configured to control the force exerted on the load good and/or a movement of the contact device by means of the actuator, in dependence, among others, on the signal of the vibration detection device.

In this context, it can be provided that the vibration detection device is configured to determine the vibration state anew for a subsequent load good of the same type in the case of several successively conveyable load goods and, if necessary, to determine new control parameters for damping the vibration. It is thus possible first of all to detect a vibration state of the load good by means of the vibration detection device and, for example, to calculate in advance where the load good will be at the time of contact between the contact device and the load good. In order to enable contact between the contact device and the load good to be established with as little force as possible, the contact device can at least partially and/or at times follow the vibrating or oscillating movement of the load good, for example without actually touching the load good. Contact can then be established, for example, at the dead centre of the oscillating or vibrating movement. When the oscillating or vibrating movement is then reversed, the contact device can apply the force acting against the direction of movement of the load good to the load good by means of the actuator.

In one embodiment in can be provided that the force exerted on the load good can be in the form of a pushing force or/and a pulling force. Depending on the configuration of the contact device, it can be possible to apply only a pushing force (e.g. when “pushing” the load good), only a pulling force (e.g. when “pulling” by means of a hook) or both forms of force (e.g. with a gripper or an electromagnet).

A further development of the invention provides that the control device is configured to receive information about the load good conveyed by the conveying device from the overhead conveyor system and to process it further. For example, the overhead conveyor system can transmit information to the control device regarding the geometric dimensions of the load good, its oscillating mass or weight and/or the current position of the conveying device relative to the damping device. This enables the damping device to position the contact device at the correct place on the load good and to make the contact as shock-free as possible.

It can be advantageous in an embodiment to provide that the damping device can be controlled by means of the control device such that the contact device can be moved along with the load good at least over a portion of a path section of the overhead conveyor system. This enables a damping of a possibly existing oscillating or vibrating movement already during the transport of the load good and thus reduces the necessity of a longer swinging out distance or a waiting time at a waiting position.

In this context it can be provided that the contact device is at least at times in mechanical contact with the load good during the moving along.

It can thereby be provided that by means of the actuator the force necessary for damping a possibly existing vibration movement is transmitted to the load good via the contact device. The contact between the contact device and the load good can, for example, consist of the contact device merely resting against the surface of the load good during the force transmission. Alternatively or in addition, the contact device may comprise a switchable electromagnet, a gripping tool such as a hook or a gripper or some other type of contact device for transmitting pushing forces, pulling forces or both pushing and pulling forces.

In a configuration of the invention it can be provided that the vibration detection device comprises an optical sensor and/or an electrical sensor and/or a mechanical sensor for detecting a state of movement of the load good. The optical sensor can, for example, be a light barrier arrangement or a camera system. The electrical sensor can, for example, be a capacitive proximity sensor, an ultrasonic motion detector or similar.

The damping device is preferably configured as a multi-axis robot. A multi-axis robot is here understood to be an industrial robot or robot arm which has a manipulator with at least two axes and the contact device as an effector. By means of the two axes, the contact device can be positioned on the load good and the force can be applied to the load good.

Preferably the damping device comprises at least one passive damping element. The passive damping element can be, in a manner known per se, a vibration damper for damping mechanical vibrations, which, for example, can absorb kinetic energy by means of internal friction. Possible configurations of such a vibration damper can, for example, comprise a piston-cylinder arrangement with a damping fluid (liquid, gas) or a buffer element consisting of a material that absorbs mechanical energy.

The method according to the invention for damping vibrations of load goods of an overhead conveyor system, wherein by means of the overhead conveyor system load goods can be conveyed overhead by conveying devices, comprises the steps of conveying a load good along a path section, detecting a vibration state of the load good and actively exerting a force on the load good by means of a damping device, taking into account the state of vibration of the load good.

### BRIEF DESCRIPTION OF THE DRAWINGS

In the following, embodiments of the invention are explained in more detail on the basis of the drawings.

FIG. 1 shows a schematic representation of an overhead conveyor system in a side partial view;

FIG. 2 shows a cross-sectional view of the overhead conveyor system of FIG. 1;

FIGS. 3, 4 show the overhead conveyor system of FIGS. 1 and 2 in exemplary vibration states;

FIG. 5 shows a schematic cross-sectional view of a damping station according to the invention for the overhead conveyor system of FIGS. 1-4;

FIG. 6 shows a plan view of a track section of the overhead conveyor system of FIGS. 1-4 without a damping station;

FIG. 7 shows a plan view of FIG. 6 with a damping station according to the invention;

FIG. 8 shows a schematic cross-sectional view of an alternative embodiment of an overhead conveyor system according to the invention;

FIG. 9 shows a schematic cross-sectional view of a further alternative embodiment of an overhead conveyor system according to the invention; and

FIG. 10 shows a flow chart for a method according to the invention.

### DESCRIPTION OF PREFERRED EMBODIMENTS

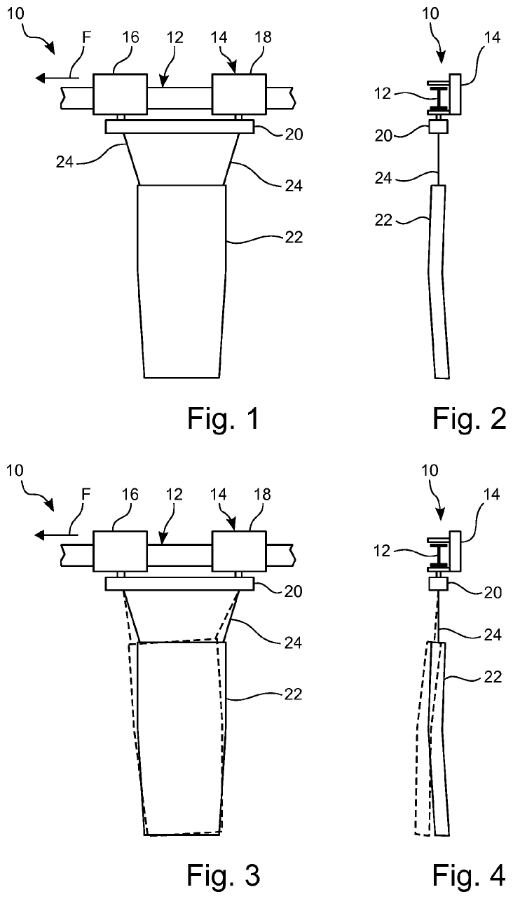

FIGS. 1 and 2 show schematic representations of a side partial view (FIG. 1) and a cross-sectional view of an overhead conveyor system 10. The overhead conveyor system 10 is configured as an electric overhead conveyor in the embodiment of FIGS. 1-4. However, this is only exemplary. Alternatively, the overhead conveyor system 10 could also be configured in a different circular conveyor technology as a power and free drag conveyor, or in another different technology as explained at the beginning.

The overhead conveyor system 10 comprises a mounting rail and drive rail system 12, on which conveying devices 14 are drivably mounted. Conveying devices 14 can, for example, have a drive unit 16 and a carrying unit 18, which are, for example, hinged to a transport frame 20. In the embodiment shown, a load good 22 is movably suspended from the transport frame 20 by means of two chains 24. In the embodiment shown, the suspension points of the chains 24 on the transport frame 20 are arranged one behind the other in the conveying direction (represented by the arrow F). Instead of the chains 24, rods, ropes or the like could also be provided. In any case, an articulated suspension of the load good 22 below the conveying device 14 results, which allows an oscillating or vibrating movement of the load good 22 relative to the conveying device 14, especially with a component perpendicular to the conveying direction F.

This is illustrated in FIGS. 3 and 4. FIGS. 3 and 4 show possible deflection positions of the load good 22 relative to the rest position with dotted outlines. FIG. 3 shows a possible oscillation or vibration movement of the load good 22 in the conveying direction F, while FIG. 4 illustrates such a movement of the load good 22 perpendicular to the conveying direction F. Of course, a combined superposition of the movement components shown in FIGS. 3 and 4 is also possible, for example as an elliptical oscillation or vibration movement.

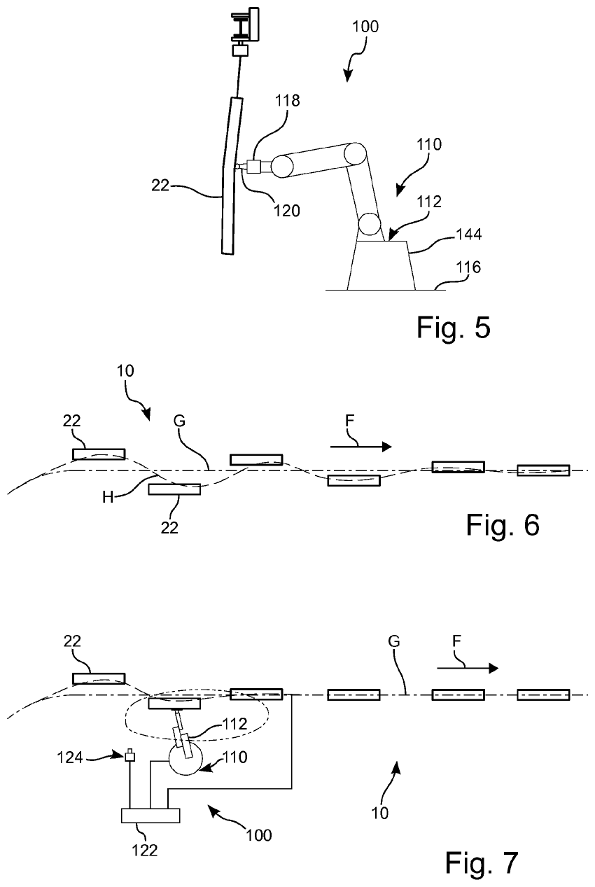

FIG. 5 shows in a schematic cross-sectional view corresponding to FIGS. 2 and 4 a part of a damping station 100 for the overhead conveyor system 10, as shown in FIG. 5, comprising a damping robot 110, which, as shown, comprises a multi-axis industrial robot arm 112. The robot arm 112 in the embodiment shown is anchored with its base 114 stationary on the floor 116 and has a contact device 118 at its end facing the load good 22. The contact device 118 can be configured according to the requirements resulting from the size, the mass and the possible speeds of the load good 22. For example, the contact device 118 can have a passive-damping damping member 120 which is capable of absorbing mechanical kinetic energy in the sense of a damping element also known as a shock absorber. The damping member 120 can accordingly be configured, for example, as a piston-cylinder arrangement with a fluid suitable for damping or have a corresponding shock-absorbing material.

In the embodiment shown in FIG. 5, the robot arm 112 engages the load good 22 by means of the contact device 118 approximately centrally with respect to the vertical extension (and with respect to the horizontal extension, but not visible here) of the load good 22, i.e. approximately at the center of gravity. However, the control system could also specify contact points above or below the center of gravity. Considerations/calculations regarding the total mass of the load good 22 and the force required at the momentary vibration state of the load good in comparison to the maximum force that can be applied as well as the maximum available distance can play a role here.

FIG. 6 shows the position of a load good 22 at different points in time as a dashed line of motion H relative to the actual conveying line G of the conveying device 14 (not shown in FIG. 6) of the overhead conveyor system 10 during a conveying operation in the conveying direction F. Due to a oscillating movement component perpendicular to the conveying direction F, the load good performs a slightly damped oscillation about the actual conveying line G. In order to damp this oscillation over a shorter distance, the damping station 100 is provided within the overhead conveyor system 10, as shown in FIG. 7. The damping station 100 comprises the damping robot 110, as already explained in FIG. 5, a control device 122 and a vibration detection device 124 within the damping station 100. The control device 122 is connected to the damping robot 110, the vibration detection device 124 and the overhead conveyor system 10 via lines not further specified.

In the example shown, the vibration detection device 124 is configured as a video camera and is accordingly configured to make successive recordings of a load good 22 conveyed along conveyor line G. The processing of the recordings of the load good 22 can either already be performed in the vibration detection device 124 or in the control unit 122. In doing so, the vibration state of the load good 22 can be determined and thus it can be calculated in advance when and where the load good 22 will be located. With the present embodiment it is not necessary to make a particularly accurate prediction, since the contact device 118 of the robot arm 112 has a passive-damping damping member 120 which, due to its damping properties, allows a certain spatial tolerance in the positioning of the contact device 118.

The detection of the vibration state of the load good 22 can be improved by transmitting information about the conveying state of the overhead conveyor system 10 to the control unit 122. For example, the controller 122 can receive information on the size, mass and speed of the load good 22 from the overhead conveyor system 10 and process it accordingly.

After the vibration state of the load good 22 has been detected and the probable movement sequence (i.e. the motion line H) of the load good 22 has been determined, the robot arm 112 can be controlled for a first contact with the load good 122 such that the contact device 118 is positioned at one of the reversal points of the oscillations of the load good 22. This position is shown in FIG. 7 for the robot arm 112. After contacting the load good 22 with the contact device 118, such a force can be exerted on the load good 22 that, mathematically speaking, the aperiodic limit case occurs for the oscillating movement and the movement component perpendicular to the conveying direction F or perpendicular to the conveying line G is completely compensated by the application of a corresponding force when reaching the conveying line G. In the situation shown in FIG. 7, it is necessary for the contact device 118 to contact the load good 22 such that a pulling force can be applied to the load good 22. For this purpose, a suitable gripping tool, such as a mechanical gripper or an electromagnet, can be provided on the contact device 118. For example, the contact device 118 can act on the suspension points of the chains 24. Alternatively, the contact device 118 can also follow the load good 22 at first at a small distance until the oscillation movement changes direction again and can then exert a thrust force on the vibrating load good 22 against the direction of movement of the same.

In this context, it may be advantageous to select a oscillation reversal point (as opposed to the oscillation reversal point shown in FIG. 7) which only requires the imposition of a pushing force (and no pulling force) on the load good 22 to dampen the vibration movement of the load good 22.

During the active damping of the oscillation movement of the load good 22, the robot arm 112 is controlled such that the contact device 118 follows the load good 22 along its conveying direction F during the damping process—i.e. the application of the force directed against the oscillating movement—until the load good 22 has reached the actual conveying line G and the motion component perpendicular to the conveying line G is completely compensated. If necessary, it may also be necessary to perform a damping process beyond the conveying line G. This then means that the oscillation movement cannot be stopped in a first oscillation movement and the damping/braking process must be performed between several reversal points. This may be the case, for example, if the damping device cannot apply the maximum force required to compensate for the oscillation movement of the load good between one reversal point and the conveying line.

The contact device 118 may be configured such that it only exerts a force on the load good 22 at points. Alternatively, the contact device 118 can also have a longitudinal extension aligned with the dimensions of the load good 22, be configured as a planar element or have several contact points or surfaces. The contact points, surfaces or rails may have a wear-resistant material at the contact points or may be deliberately configured as a wearing part. The actual contact element can be guided movably relative to the robot arm 112 and buffered with a damping element 120.

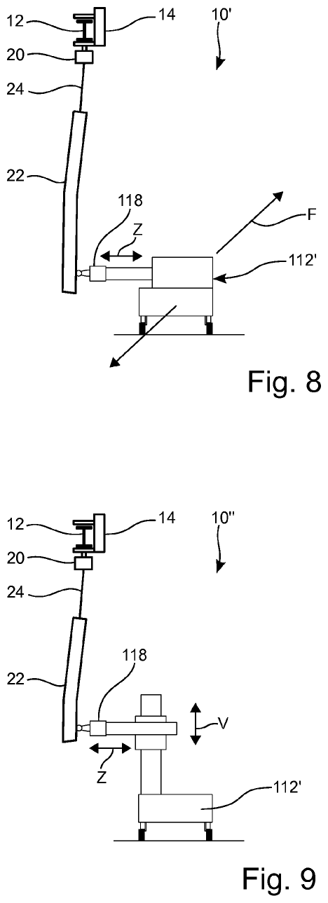

FIG. 8 shows a schematic cross-sectional view of an alternative embodiment of an overhead conveyor system 10′. For identical or comparable characteristics, the same reference sign is used. In order to avoid repetition, no new description of such characteristics is given. Corresponding but modified characteristics are marked with an apostrophe. The overhead conveyor system 10′ of FIG. 8, unlike that of FIGS. 1-7, has a 100′ damping device equipped with two axes of movement instead of an industrial robot. The damping device 100′ can be moved with its basic body 112′ along a travel axis which is parallel to the conveying direction F. A contact device 118 is movable along a feed axis Z in the direction towards the load good 22 and away from the load good 20 in accordance with a possible oscillating movement of the load good 22. This simplified version of an overhead conveyor system 10′ does not provide for height adjustment of the contact device 118. This can be disadvantageous in the case of unusually strong oscillating movements or very strongly varying load dimensions and masses. This is countered by the advantages of a simple and robust design of the overhead conveyor system 10′.

FIG. 9 illustrates in a representation similar to FIG. 8 likewise an alternative embodiment of an overhead conveyor system 10″. In contrast to the overhead conveyor system 10′ of FIG. 8, the contact device 118 in the embodiment shown in FIG. 9 is movable along an additional vertical axis V. This avoids the disadvantages of the embodiment as shown in FIG. 8 and can still be implemented as a simple, robust and cost-efficient design.

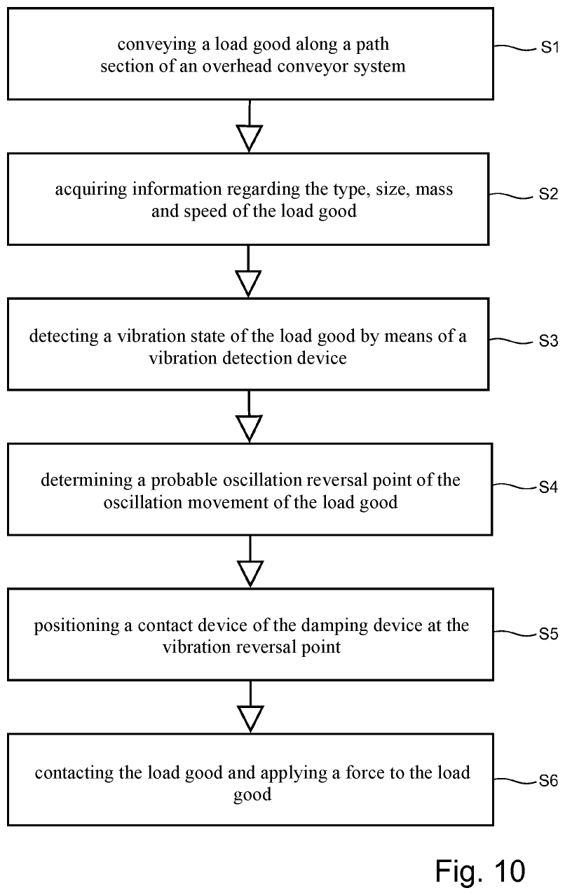

FIG. 10 illustrates a schematic diagram of a method in accordance with the invention. In a first step, the method involves conveying a load good along a path section of an overhead conveyor system. The conveying process can be a uniform, unaccelerated or accelerated movement.

In order to improve the determination of a vibration state of the load good and to improve damping of a possible vibration movement by suitable positioning of a contact device of a damping device, information regarding the type, size and mass of the load good can be stored in the overhead conveyor system and, if necessary, transmitted (S2) to a control device of a damping device. In addition to the above parameters, information on the momentary speed and on any acceleration (increasing or decreasing speed) of the load good which may be occurring by a conveying device of the overhead conveyor system can also be acquired and transmitted to a control device.

In a further step, which may follow or precede the step described above, a vibration state of the load good may be detected by means of a vibration detection device (S3). The vibration detection device may be a camera such as an inspection camera that is already present or sensors that are specially configured for vibration detection.

On the basis of the recorded information, a probable oscillation reversal point of a possibly existing oscillation movement of the load good is determined (S4).

A contact device of a damping device is positioned at the vibration reversal point such that the load good can be contacted as shock-free as possible (S5). However, it is not necessary that the contacting takes place exactly at the oscillation reversal point. This merely represents a particularly preferred contact point. In a last step S6, the load good is contacted and a force is applied to the load good by means of the contact device such that when the actual conveying line is reached, the load has no movement component perpendicular to the conveying line.

What is claimed is:

1. A damping station for an overhead conveyor system for damping vibrations of load goods, wherein by means of the overhead conveyor system load goods can be conveyed overhead by conveying devices, comprising:
a) a vibration detection device configured to generate a signal corresponding to a mechanical vibration state of a load good suspended on a conveying device,
b) a damping device with a mechanical contact device which is movable by means of an actuator, the contact device being configured to engage in a mechanical operative connection with the load good suspended on the conveying device by means of the actuator,
c) a control device connected at least to the vibration detection device and the damping device,
wherein the control device is configured to control the damping device in dependence on the signal of the vibration detection device such that by means of the actuator a force is exerted on the load good via the contact device such that a vibration of the load good is damped.

2. The damping station according to claim 1, wherein the control device is configured to control the force exerted on the load good and/or a movement of the contact device by means of the actuator in dependence on at least the signal of the vibration detection device.

3. The damping station according to claim 1, wherein the force exerted on the load good can be in the form of a pushing force or/and a pulling force.

4. The damping station according to claim 1, wherein the control device is configured to receive information about the load good conveyed by the conveying device from the overhead conveyor system and to process it further.

5. The damping station according to claim 1, wherein the damping device can be controlled by means of the control device such that the contact device can be moved along with the load good at least over a portion of a path section of the overhead conveyor system.

6. The damping station according to claim 5, wherein the contact device is at least at times in mechanical contact with the load good during the moving along.

7. The damping station according to claim 6, wherein the contact device (118) exerts the force on the load good (22) during the mechanical contact.

8. The damping station according to claim 1, wherein the vibration detection device comprises an optical sensor and/or an electrical sensor and/or a mechanical sensor for detecting a state of movement of the load good.

9. The damping station according to claim 1, wherein the damping device is configured as a multi-axis robot.

10. The damping station according to claim 1, wherein the damping device comprises at least one passive damping element.

11. Overhead conveyor system (10) with a damping station according to claim 1.

12. A method for damping vibrations of load goods of an overhead conveyor system, wherein by means of the overhead conveyor system load goods can be conveyed overhead by conveying devices, comprising the steps:
a) conveying a load good along a path section;
b) detecting a vibration state of the load good; and
c) actively exerting a force on the load good by means of a damping device, taking into account the state of vibration of the load good.
